(19) United States
(12) Patent Application Publication
(10) Pub. No.: US 2026/0288326 A1
(43) Pub. Date: Sep. 24, 2026

(54) INFOTAINMENT SYSTEM FOR VEHICLE AND WIRELESS INPUT DEVICE FOR CONTROLLING AUXILIARY SYSTEM OF VEHICLE

(71) Applicant: Honda Motor Co., Ltd., Tokyo (JP)

(72) Inventors: Saul Mijael Ibaven Bueno, Columbus, OH (US); Jorge Navarro Valdes, Marysville, OH (US); Edgar Fernandez Vergara, Columbus, OH (US); Yumiko M. Bragg, Columbus, OH (US); Steven Feit, Dublin, OH (US); Robert Chaney, Hilliard, OH (US)

(21) Appl. No.: 19/082,513

(22) Filed: Mar. 18, 2025

(51) Int. Cl. G06F 3/0487; B60H 1/00; B60S 1/06; E05F 15/76; G06F 3/0482; G06F 3/0484

(52) U.S. Cl. CPC G06F 3/0487; B60H 1/00985; B60S 1/06; E05F 15/76; E05Y 2400/66; E05Y 2900/55; G06F 3/0482; G06F 3/0484

(57) ABSTRACT

A vehicle includes a plurality of auxiliary systems to provide a plurality of auxiliary functions of the vehicle. The vehicle also includes an infotainment system having a user interface and a controller communicatively coupled to the plurality of auxiliary systems and the user interface. The controller is configured to detect a presence of a wireless input device inside the vehicle, determine at least one auxiliary system out of the plurality of auxiliary systems suitable to be associated with the wireless input device, and display an indication, via the user interface, representing the at least one auxiliary system suitable to be associated with the wireless input device. The controller is further configured to receive an input, via the user interface, selecting one of the at least one auxiliary system. Moreover, the controller is configured to associate a control of the selected auxiliary system with the wireless input device.

### BACKGROUND

The disclosed subject matter relates generally to a vehicle. More particularly, the disclosed subject matter relates to an infotainment system for a vehicle that enables a control of at least one auxiliary system of the vehicle via a wireless input device.

There is currently a mix of vehicles in the market with some of the vehicles having physical switches, each dedicated to a single function, while other of the vehicles have completely removed such switches. Physical switches have a fixed location and are limited to a specific function, which cannot be modified by the end user. For the vehicles without physical switches, functions are, generally, controlled from a center touchscreen. In such a case the user needs to change all settings using the center display, which may require multiple touches to access and change a setting.

### SUMMARY

In accordance with one embodiment of the present disclosure, a vehicle is provided. The vehicle includes a plurality of auxiliary systems to provide a plurality of auxiliary functions of the vehicle. The vehicle also includes an infotainment system having a user interface and a controller communicatively coupled to the plurality of auxiliary systems and the user interface. The controller is configured to detect a presence of a wireless input device inside the vehicle, determine at least one auxiliary system out of the plurality of auxiliary systems suitable to be associated with the wireless input device, and display an indication, via the user interface, representing the at least one auxiliary system suitable to be associated with the wireless input device. The controller is further configured to receive an input, via the user interface, selecting one of the at least one auxiliary system. Moreover, the controller is configured to associate a control of the selected auxiliary system with the wireless input device.

In accordance with another embodiment of the present disclosure, an infotainment system for a vehicle is provided. The vehicle includes a plurality of auxiliary systems to provide a plurality of auxiliary functions of the vehicle. The infotainment system includes a user interface to facilitate an interaction with a user of the vehicle, and a controller communicatively coupled to the plurality of auxiliary systems and the user interface. The controller is configured to detect a presence of a wireless input device inside the vehicle, and determine one or more auxiliary systems out of the plurality of auxiliary systems suitable to be associated with the wireless input device. Moreover, the controller is configured to display, via the user interface, to a user the one or more auxiliary systems suitable to be associated with the wireless input device. Furthermore, the controller is configured to associate a control of a selected auxiliary system out of the determined one or more auxiliary systems with the wireless input device based on a selection by the user.

In accordance with yet a further embodiment of the present disclosure a wireless input device is provided. The wireless input device enables a user to control a plurality of auxiliary systems of a vehicle. The plurality of auxiliary systems of the vehicle provide a plurality of auxiliary functions of the vehicle. The vehicle further includes an infotainment system. The wireless input device includes a transceiver to facilitate a short-range wireless communication with the infotainment system, and an input interface to receive input from the user. Moreover, the wireless input device includes a controller communicatively coupled to the transceiver and the input interface. The controller is configured to enable, via the transceiver, a pairing of the wireless input device with the infotainment system, and associate a control of one of the plurality of auxiliary systems of the vehicle to the wireless input device. The controller is further configured to generate control instructions, based on input received from the user via the input interface, to control the associated auxiliary system of the vehicle.

### BRIEF DESCRIPTION OF THE DRAWINGS

Certain embodiments of the present disclosure will be better understood from the following description taken in conjunction with the accompanying drawings in which:

FIG. 1 is a schematic view of a vehicle system having a vehicle and a wireless input device arranged inside the vehicle, in accordance with one embodiment of the present disclosure;

FIG. 2 illustrates a portion of an interior of the vehicle depicting an infotainment system and the wireless input device arranged inside the vehicle, in accordance with one embodiment of the present disclosure;

FIG. 3 is a schematic view of the wireless input device depicting various components of the wireless input device, in accordance with one embodiment of the present disclosure; and

FIG. 4 is a block diagram of the vehicle system of FIG. 1 and schematically depicting various components of the vehicle and the wireless input device, in accordance with one embodiment of the present disclosure.

### DETAILED DESCRIPTION OF EXEMPLARY EMBODIMENTS

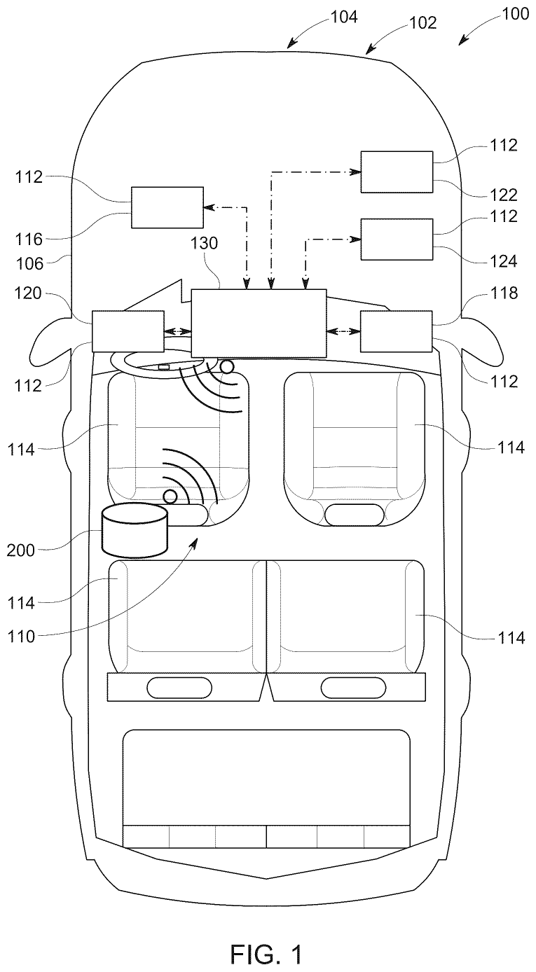

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-4, wherein like numbers indicate the same or corresponding elements throughout the views.

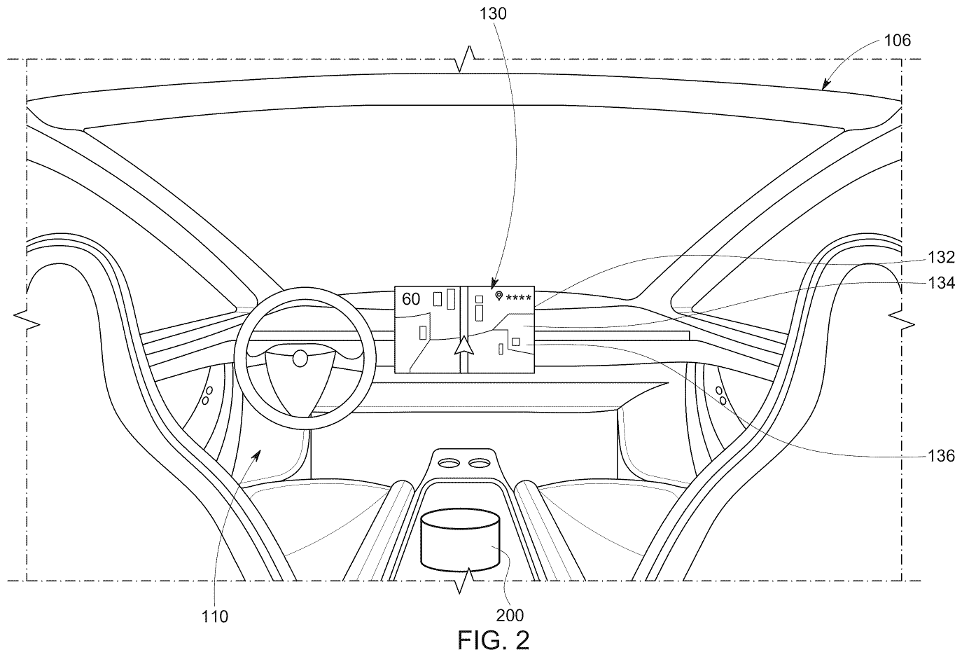

FIGS. 1, 2, and 4 illustrates a side perspective view of a vehicle system, indicated generally at 100, and having a vehicle 102 and a wireless input device 200 adapted to be used with the vehicle 102 in accordance with one embodiment of the present disclosure. The vehicle 102 is shown as a sedan 104. However, vehicle 102 in accordance with alternative embodiments can comprise any variety of vehicles, including trucks, vans, recreational vehicles, utility vehicles, agricultural equipment, or construction equipment, for example. Referring to FIGS. 1 and 2, the vehicle 102 includes a vehicle body 106 to which various components of the vehicle 102 are mounted, and a plurality of traction members, for example, wheels, movably supporting the vehicle body 106 on a ground surface. Also, the vehicle body 106 defines a passenger compartment 110 with a plurality of seats 114 arranged inside the passenger compartment 110 to facilitate seating of one or more passengers/users inside the vehicle 102.

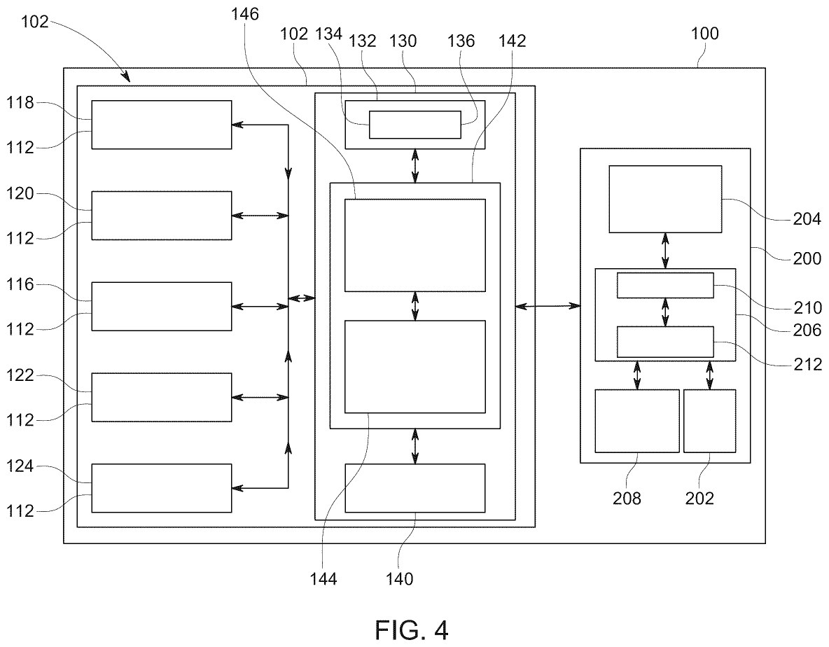

Moreover, the vehicle 102 includes a plurality of auxiliary systems 112, shown in FIG. 2 and FIG. 4, to provide a plurality of auxiliary functions of the vehicle 102. For example, the plurality of auxiliary systems 112 may include an air conditioning system 116 to heat and cool the passenger compartment 110, an indicator system 118 to control left and right indicators of the vehicle 102, an electric window system 120 to control an opening and closing of windows of the vehicle 102, a lighting system 122 for controlling external lights of the vehicle 102, a wiper and windshield washer system 124 to control wipers of the vehicle 102, and any other auxiliary systems of the vehicle 102 that are configured to be operated/controlled by a user of the vehicle 102 seating inside the passenger compartment 110.

Further, the vehicle 102 includes an infotainment system 130 to provide a combination of entertainment and information to the driver and the passengers through audio/video interfaces. To facilitate such a functionality, referring to FIGS. 2 and 4, the infotainment system 130 includes a user interface 132 having a display screen 134 to display one or more information related to one or more functional parameters of the vehicle 102 as well as video content. Moreover, the user interface 132 is configured to enable the user of the vehicle 102 to interact with the infotainment system 130 and receive an input from the user. For so doing, in some embodiments, the user interface 132 may include a keypad. Alternatively, the display screen 134 is a touch enabled screen 136 and may include virtual buttons to enable a user to receive input from the user.

Further, the infotainment system 130, referring to FIG. 4, includes a transceiver 140 to facilitate a communication and data exchange with the auxiliary systems 112 of the vehicle 102. Moreover, the infotainment system 130 includes a controller 142 communicatively coupled to the user interface 132, the transceiver 140, and the plurality of auxiliary systems 112. The transceiver 140 of the infotainment system 130 may be short-range transceiver. In some embodiments, the transceiver 140 may be a BLUETOOTH transceiver, a near field communication (NFC) device, an ultrawide band sensor, or any other similar transceiver known in the art. The controller is configured to control various functionality of the infotainment system 130 and also facilitates in configuring the wireless input device 200 with at least one of the auxiliary systems 112, selected by the user, to enable the user to control one or more functions of the selected auxiliary system 112. In an embodiment, the controller 142 may be an electronic control unit of the vehicle 102 and may be configured to control various electrical and electronic components of the vehicle 102 including the auxiliary systems 112.

The controller 142 includes a processor 144 and a memory 146 to respectively process and store the data, for example control instructions, received from the device 200 and other electrical and electronic component of the vehicle 102. In some embodiments, the instructions to configure and reconfigure the device 200, and the data related to the control and functioning of the auxiliary systems 112 and the infotainment system 130 are stored inside the memory 146 of the controller 142.

The memory 146 may be integrated into the controller 142, but those skilled in the art will understand that the memory 146 may be separate from the controller 142 but onboard the vehicle 102, and/or remote from the controller 142 and the vehicle 102, while still being associated with and accessible by the controller 142 to store information in and retrieve information from the memory 146 as necessary during the operation of the vehicle 102 i.e., the infotainment system 130 and the auxiliary systems 112 and during configuring and reconfiguring of the device with one of the auxiliary systems 112. Although the processor 144 is contemplated, it is also possible and contemplated to use other electronic components such as a microcontroller, an application specific integrated circuit (ASIC) chip, or any other integrated circuit device. The processor 144 is configured to execute specified instructions, which controls and monitors various functions associated with the infotainment system 130, the auxiliary systems 112, and its components, etc., controls and monitors the configuring and reconfiguring of the device 200 with a desired one of the auxiliary systems 112, and control the configured auxiliary system 112 via the device 200.

The transceiver 140 and/or controller 142 of the infotainment system 130 may be configured such that the transceiver 140 interacts with the device 200 and receives control instructions from the device 200 only when the device 200 is arranged inside the passenger compartment 110 of the vehicle 102. In some embodiments, the controller 142 i.e., the processor 144 may be configured to pair with the device 200 only when the controller 142 determines that the device 200 is arranged inside the vehicle 102 to enable the configuring of the device 200 with a control of one of the plurality of auxiliary systems 112 of the vehicle 102. In some embodiments, the controller 142 determines the presence of the device 200 inside the vehicle 102 in response to a detection of a physical contact of the device 200 with the user interface 132, for example, the touch enabled screen 136, of the infotainment system 130 of the vehicle 102. In some embodiments, the controller 142 may restrict a distance to which the transceiver 140 is configured to interact with any external device, for example, the device 200, and determines the presence of the device 200 inside the vehicle 102 when the transceiver 140 detects and interacts with the device 200. In some embodiments, the controller 142 is configured to detect the presence of the device 200 inside the vehicle 102 based on the time of flight of the signal transmitted from the transceiver 140 and receipt of a response of the device 220. It may be envisioned that the controller 142 may detect whether the device 200 is arranged inside the vehicle 102 or outside the vehicle 102 based on any means or mechanism known in the art and is not limited by the means of methods described in the present disclosure.

Upon detection of presence of the device 200 inside the vehicle 102, the controller 142 i.e., the processor 144 is configured to pair the device 200 with the infotainment system 130 to allow a data exchange with the device 200. Also, upon pairing, the device 200 is configured to share a device identification reference of the device 200 with the controller 142, and the controller 142 based on the device identification reference identifies the type of device. Based on the type of device, the controller is configured to determine at least one auxiliary system 112 out of the plurality of auxiliary systems 112 with which the device 200 may be associated, and displays, via the user interface 132, an indication representing the determined at least one auxiliary system 112 to the user via the display screen 134 of the infotainment system 130. In an embodiment, the controller 142 may display a name of the determined at least one auxiliary system 112 on the display screen 134.

Moreover, the controller is configured to prompt, via the user interface, the user, to select one of the determined at least one auxiliary system 112 to initiate a configuring/reconfiguring of the device 200 with selected auxiliary system 112 of the vehicle 102. Upon receipt of the selection from the user, via the user interface 132, the controller configures/associates the control of the selected auxiliary system 112 with device 200. In some embodiments, the controller 142 may also provide a list of functions, via the display screen 134, of the selected auxiliary system 112 suitable to be associated with the device, and prompts, via the user interface 132, the user to select one of the listed functions via the user interface 132. Upon receipt of an input from the user interface 132 corresponding to the selection of one of the functions, the controller 142 is configured to generate suitable configuring instructions and configure/associate the control of the selected function of the selected auxiliary system 112 of the vehicle 102 with the device 200.

Upon such configuration, the controller 142 may be configured to transmit a message to the device 200 having details of the function and the configured auxiliary system 112. In some embodiments, the device 200 may display a name of the configured function and/or a name of the configured auxiliary system 112. Further, the device 200 may be reconfigured to another function of the configured auxiliary system 112 and/or any other auxiliary system 112 of the vehicle 102. For initiating the reconfiguration of the device 200, the user physically contacts device 200 with the infotainment system 130, and the controller 142 initiates the reconfiguration and displays a list of the auxiliary systems 112 that are available for configuration with the device 200 via the user interface 132 i.e., the display screen 134. Thereafter, upon receipt of a selection from the user, the controller 142 reconfigures the device 200 to selected auxiliary system 112.

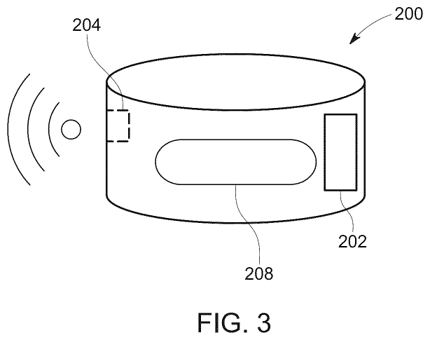

Referring to FIG. 3, the device 200 is shown. The device 200 is a stand-alone device that can be moved to any desired location inside the vehicle 102 and configured to be paired with the infotainment system 130 to the vehicle 102. As shown, the device 200 includes an input interface 202 to facilitate the user to provide input to control a function of the configured auxiliary system 112 of the vehicle 102. In an embodiment, the input interface 202 may be at least one of a button, a switch, and a rotatable knob. Further, the device 200 includes a transceiver 204 that facilitates a short-range wireless communication to communicate and exchange data with another device for example, the infotainment system 130 of the vehicle 102 and a controller 206, shown in FIG. 4, configured to generate control instructions based on input received from the user via the input interface 202 and share, via the transceiver 204, the generated control instructions to an external device for example, the controller 142 of the vehicle 102 to control the configured auxiliary system out of the plurality of auxiliary systems 112. The transceiver 204 may be a BLUETOOTH transceiver, a near field communication (NFC) device, an ultrawide band sensor, or any other similar transceiver known in the art.

Moreover, the controller 206 facilitates the pairing, configuring, and reconfiguring of the device 200 with the desired auxiliary system and facilitates the infotainment system 130 i.e., the controller 142 to identify a type/an identity of the device 200. For so doing, the controller 206 is configured to share a device identification reference indicating the type of the device 200 to the infotainment system 130.

Further, the controller 206 is configured to receive an indication from the infotainment system 130 i.e., the controller 142 indicating/confirming the association of the device 200 with the desired auxiliary system 112 and details of the configured auxiliary system 112. In some embodiments, the controller 206 may display a message displaying a name of the auxiliary system 112 with which the device 220 is configured. In some embodiments, for initiating the configuration/association of the device 200 with one of the auxiliary systems 112 of the vehicle 102, and a data exchange between device 200 and the infotainment system 130, the controller 206 may determine a physical contact of the device 200 with the user interface 132 of the infotainment system 130, for example, the touch enabled screen 136, and shares the device identification reference with the controller 142 of the infotainment system 130 upon detection of such physical contact.

As shown in FIG. 4, the controller 206 includes a processor 210 and a memory 212 to respectively process and store the data to enable pairing and configuring of the device 200 with any one of the auxiliary systems 112 of the vehicle 102. The memory 212 may be integrated into the controller 206, but those skilled in the art will understand that the memory 212 may be separate from the controller 206 but onboard the device 200, and/or remote from the controller 206 and the device 200, while still being associated with and accessible by the controller 206 to store information in and retrieve information from the memory 212 as necessary during the operation of the device 200. Although the processor 210 is contemplated, it is also possible and contemplated to use other electronic components such as a microcontroller, an application specific integrated circuit (ASIC) chip, or any other integrated circuit device.

A method for configuring the device 200 one the plurality of auxiliary systems 112 of the vehicle 102 is now disclosed. For initiating the configuration of the device 200, the controller 142 of the infotainment system 130 detects/determines a presence of the device 200 inside the vehicle 102. Upon detecting the presence of the device 200 inside the vehicle 102, the controller 142 facilitates the pairing of the device 200 with the infotainment system 130, and receives the device identification reference from the device 200 i.e., controller 206 of the device 200. The controller 142, upon receipt of the device identification reference, determine the type of the device 200 based on the device identification reference. In some embodiments, the controller 142, i.e., processor 146 may access a database stored inside the memory 146 and having a list of type of devices associated with a plurality of device identification references, and determines the type of device by comparing the received device identification reference with the stored device identification references. Further, the controller 142 identifies/determines at least one auxiliary system 112, for example, the air conditioning system 116 and the electric window system 120, that can be associated with the device 200 based on the type of the device 200. The controller 142 may store such an information for each type of devices, and identifies the at least one auxiliary system 112 by using the type of device accordingly.

Upon determination/identification of the at least one auxiliary system 112, for example, the air conditioning system 116 and the electric window system 120, out of the plurality of auxiliary systems 112, the controller 142 displays the names of the determined at least one auxiliary system, the air conditioning system 116 and the electric window system 120, to the user via the user interface 132 i.e., display screen 134 of the infotainment system 130. Also, the controller 142 prompts the user to select one of the displayed auxiliary systems, for example, the air conditioning system 116 and the electric window system 120, and upon selection by the user, via the user interface 132, the controller 142 configures/associates the control of the selected auxiliary system 112, for example, the air conditioning system 116 to the device 200.

In some embodiments, controller 142, upon receipt of the selection of one of the displayed auxiliary systems 112, may display a list of functions of the selected auxiliary systems, for example, the air conditioning system 116, and prompts the user to select a function out of the plurality of functions that the user intends to control via the device 200. Upon receipt of such a selection, the controller 142 configures the controls of the selected function to the device 200. Upon configuration of a desired auxiliary system 112, for example, the air conditioning system 116, the controller 142 shares a name of the configured auxiliary system 112 with the device 200 and the device 200 may display such name via a display 208 of the device 200. In some embodiments, the controller 142 also shares an identification related to the configured function with the device 200 and the controller 206 of the device 200 shows identification, for example, name of the function, via the display 208 of the device 200.

After configuration/association of the desired auxiliary system 112, for example, the air conditioning system 116 with device 200, the user operates the device 200 to control the auxiliary system 112 via the input interface 202. Upon receipt of the input from the user, via the input interface 202 of the device 200, the controller 206 i.e., processor 210 of the device 200 generates one or more control instructions to control the function of the configured auxiliary system 112 i.e., the air conditioning system 116, based on the received input. The controller 206 shares/transmits the one or more control instructions to the controller 142 of the vehicle 102 via the transceiver 204 of the device 200. Upon receipt of the control instructions from the device 200, the controller 142 controls the associated function of the configured auxiliary system 112, for example the air conditioning system 116, based on the received control instructions from the device 200. In this manner, the device 200 is configured and used to control at least one auxiliary system 112 of the vehicle 102 from anywhere inside the vehicle 102 as the device 200 can be moved and positioned at any location inside the vehicle 102.

A method for reconfiguring the device 200 to another auxiliary system 112, for example, the electric window system 120, out of the determined auxiliary systems, for example, the air conditioning system 116 and the electric window system 120, of the vehicle 102 is now described. For reconfiguring the device 200 another auxiliary system 112, for example, the electric window system 120, the user makes a physical contact of the device 200 with the user interface 132 i.e., the touch enabled screen 136, of the infotainment system 130. Upon detection of the physical contact of the device 200 with the user interface 132, the controller 142 initiates the reconfiguration process of the device 200 and displays the list of determined auxiliary systems 112, for example, the air conditioning system 116 and the electric window system 120, that are suitable to be associated with the device 200. Moreover, upon detection of the physical contact of the device 200 with the user interface 132 of the infotainment system 130, the controller 206 may determine that user intends to reconfigure the device with another auxiliary system 112 of the vehicle, and removes the association of the device 200 with associated/configured auxiliary system 112. In some embodiments, the controller 206 may remove the association of the device 200 with an associated/configured auxiliary system 112 upon receiving a communication from the controller 142 that user has selected another auxiliary system 112 for configuring/associating the control of another auxiliary system 112 with the device 200. In this manner, the controller 206 facilitates the reconfiguring of the device 200 with another auxiliary system 112 of the vehicle 102.

Upon displaying the list of determined auxiliary systems 112 suitable to be associated with the device 200, the controller 142 prompts the user to select one of the displayed auxiliary systems 112. In this example, as the user desires to reconfigure the device 200, and therefore, the user selects the electric window system for configuration. Upon receipt of the selection, the controller 142 configures the selected auxiliary system 112, i.e., the electric window system 120 in a manner similar to the process of configuring the device 200 as described above. After reconfiguration of the device 200, the device 200 facilitates the user to control the auxiliary system 112 i.e., the electric window system 120 in a manner discussed previously in in the disclosure.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A vehicle, comprising:
a plurality of auxiliary systems to provide a plurality of auxiliary functions of the vehicle; and
an infotainment system including a user interface and a controller communicatively coupled to the plurality of auxiliary systems and the user interface, the controller is configured to:
detect a presence of a wireless input device inside the vehicle,
determine at least one auxiliary system out of the plurality of auxiliary systems suitable to be associated with the wireless input device,
display an indication, via the user interface, representing the at least one auxiliary system suitable to be associated with the wireless input device,
receive an input, via the user interface, selecting one of the at least one auxiliary system, and
associate a control of the selected auxiliary system with the wireless input device.

2. The vehicle of claim 1, wherein the infotainment system includes a short-range transceiver to enable a short-range communication with the wireless input device.

3. The vehicle of claim 2, wherein the transceiver includes one of a BLUETOOTH transceiver, a near field communication device and at least one ultrawide band sensor.

4. The vehicle of claim 1, wherein the controller is configured to detect the presence of the wireless input device inside the vehicle in response to a physical contact of the wireless input device with the user interface of the infotainment system.

5. The vehicle of claim 4, wherein the controller facilitates a reconfiguring of the wireless input device to the determined at least one auxiliary system upon detection of the physical contact of the wireless input device with the user interface.

6. The vehicle of claim 1, wherein the controller is configured to receive a device identification reference from the wireless input device and determines the at least one auxiliary system suitable to be associated with the wireless input device based on the device identification reference.

7. The vehicle of claim 1, wherein the plurality of auxiliary system includes at least one of an air conditioning system, an electric window system, and a wiper and windshield washer system.

8. An infotainment system for a vehicle, the vehicle includes a plurality of auxiliary systems to provide a plurality of auxiliary functions of the vehicle, the infotainment system comprising:
a user interface to facilitate an interaction with a user of the vehicle; and
a controller communicatively coupled to the plurality of auxiliary systems and the user interface, the controller is configured to:
detect a presence of a wireless input device inside the vehicle,
determine one or more auxiliary systems out of the plurality of auxiliary systems suitable to be associated with the wireless input device,
display, via the user interface, to a user the one or more auxiliary systems suitable to be associated with the wireless input device, and
associate a control of a selected auxiliary system out of the determined one or more auxiliary systems with the wireless input device based on a selection by the user.

9. The infotainment system of claim 8 further comprises a short-range transceiver to enable a short-range communication with the wireless input device.

10. The infotainment system of claim 9, wherein the transceiver includes one of a BLUETOOTH transceiver, a near field communication device, and at least one ultrawide band sensor.

11. The infotainment system of claim 8, wherein the controller is configured to detect the presence of the wireless input device inside the vehicle in response to a contact of the wireless input device to the user interface of the infotainment system.

12. The infotainment system of claim 8, wherein the controller is configured to display, via the user interface, selectable options for a reconfiguring of the wireless input device to be associated with another of the determined one or more auxiliary systems upon detection of a physical contact of the wireless input device with the user interface.

13. The infotainment system of claim 8, wherein the controller is configured to receive a device identification reference from the wireless input device and determines the one or more auxiliary systems suitable to be associated with wireless input device based on the device identification reference.

14. The infotainment system of claim 8, wherein the user interface includes a touch enabled display.

15. A wireless input device to enable a user to control a plurality of auxiliary systems of a vehicle, the plurality of auxiliary systems of the vehicle provides a plurality of auxiliary functions of the vehicle, the vehicle further includes an infotainment system, the wireless input device comprising:
a transceiver to facilitate a short-range wireless communication with the infotainment system;
an input interface to receive input from the user; and
a controller communicatively coupled to the transceiver and the input interface, the controller is configured to:
enable, via the transceiver, a pairing of the wireless input device with the infotainment system,
associate a control of one of the plurality of auxiliary systems of the vehicle to the wireless input device, and
generate control instructions, based on input received from the user via the input interface, to control the associated auxiliary system of the vehicle.

16. The wireless input device of claim 15, wherein the input interface includes at least one of a button, a switch, and a rotatable knob.

17. The wireless input device of claim 15, wherein the controller is configured to share, via the transceiver, a device identification reference with the infotainment system to enable the infotainment system to identify a type of the wireless input device to facilitate the association of a suitable auxiliary system among the plurality of auxiliary systems with the wireless input device.

18. The wireless input device of claim 15 further comprises a display a name of the associated auxiliary system.

19. The wireless input device of claim 15, wherein the controller is configured to facilitate a reconfiguring of the wireless device with one of the plurality of auxiliary system in response to a physical contact of the wireless input device with a user interface of the infotainment system.

20. The wireless input device of claim 15, wherein the controller is configured to enable the pairing of the wireless input device with the infotainment system when the wireless input device is arranged inside the vehicle.
